(19) United States
(12) Patent Application Publication
(10) Pub. No.: US 2003/0088444 A1
(43) Pub. Date: May 8, 2003

(54) Structuring and financing a variable insurance product

(76) Inventors: Mark Garbin, Bronxville, NY (US); Marshall Greenbaum, New York, NY (US)

Correspondence Address: Steven B. Pokotilow, Stroock & Stroock & Lavan LLP, 180 Maiden Lane, New York, NY, 10038, US

(21) Appl. No.: 10/271,486

(22) Filed: Oct. 15, 2002

Related U.S. Application Data
(60) Provisional application No. 60/329,588, filed on Oct. 15, 2001.

(51) Int. Cl. G06F 17/60

(52) U.S. Cl. 705/4; 705/36

(57) ABSTRACT

For a variable insurance product, a method of delivering upfront payment of funds that would otherwise be received through periodic collection of fees includes paying an insurer's distribution costs from sub-account funds, rather than from fees that are charged at the policy level. Because financing that is received for a sub-account can be immediately recognized as income, these 12b-1 fees can be sold to a financing company for a lump sum payment. An insurer can therefore, immediately obtain funds for its distribution costs, rather than wait for funds to periodically be paid by policyholder fees.

### CROSS REFERENCE TO RELATED APPLICATIONS

This claims the benefit under 35 U.S.C. §119(e) of U.S. Provisional Application for Patent Serial No. 60/329,588, filed Oct. 15, 2002, entitled Variable Annuity and Method of Providing Financing Based Thereon.

### BACKGROUND OF THE INVENTION

1. Field of the Invention

The present invention relates generally to facilitating immediate recognition of the income, under U.S. Generally Accepted Accounting Principles (“GAAP”), that will be earned at the time of sale but received over time from the sale of a variable insurance product.

2. Description of Related Art

Generally speaking, variable insurance products are policies that are sold by insurance companies, in which the benefit paid to the policyholder is “variable” because it will be funded by market-based investments. Any growth on Premium Payments 15 that is applied to these products usually grows in a tax-deferred account. The insurer will pay the policyholder a benefit based on an amount equal to the value of the invested premiums with market-based returns, less certain fees. Variable annuities, variable life insurance products (e.g. variable life, variable universal life, etc.) and similar products are examples of variable insurance products.

Variable insurance products often also include some type of death benefit, which provides that either the premiums or some other agreed upon value will be paid to a beneficiary when the policyholder dies. Variable life insurance policies are usually purchased to enable policyholders to provide for their survivors. In contrast, variable annuities are typically purchased to provide income to the policyholder during retirement. While they usually include a death benefit, this death benefit is contingent upon the policyholder's death occurring before “annuitization” of the policyholders account value. Insurers may also offer other products that have some or all of the same features.

Insurers who sell variable insurance products own “Investment Accounts,” which are registered with the Securities and Exchange Commission (SEC). Investment Accounts are segregated asset accounts, with their assets invested in one or more “sub-accounts.” Each sub-account can include a combination of stocks, bonds, mutual funds, real estate investment trusts and/or other market based financial investments. The financial instruments that are contained in each sub-account are selected by a professional investment manager called a “sub-advisor” who manages the sub-account in accordance with an identified investment objective.

Upon purchase of a variable insurance product, the policyholder usually selects the sub-accounts in which his or her premium payments are to be invested. The value of the benefit that will ultimately be delivered to the policyholder depends upon market conditions, and more specifically, upon the performance of the stocks, bonds and other investments in the sub-accounts in which the policyholder has invested. Fees will also be deducted from the value of the policy at both the insurance policy level and the sub-account level, before any benefit is delivered to the policyholder.

At the policy level, insurers deduct various fees, including as an asset based Mortality and Expense (“M&E”) fee. M&E fees are deducted periodically, as a percentage applied to the value of the policy. Most insurers use M&E fees to recoup their distribution costs of distributing variable insurance products, in addition to their mortality and expense risk costs.

At the policy level, many insurers will deduct a “contingent deferred sales charge” (“CDSC”) if the policyholder demands payment of the funds during the initial years of the policy. Variable insurance products often include a “free partial withdrawal” provision, which allows the policyholder to withdraw a portion of the policy without paying the CDSC. Insurers will then deduct CDSC charges from the policyholder's returns if funds that exceed the authorized amount are withdrawn from the policy.

The SEC authorizes sub-accounts and other investment funds to pay some of their costs from fund assets. Specifically, SEC Rule 12b-1 authorizes the use of fund assets to pay “servicing costs”—the costs of servicing shareholder accounts and “distribution costs”—the costs of distributing fund shares to shareholders, which includes marketing and selling fund shares, advertising the fund, providing prospectuses, etc. from fund shares. 12b-1 fees may only be paid by a qualified investment fund, and funds may choose not to use fund assets to pay these costs (i.e. not to pay 12b-1 fees). Thus far, the SEC has not limited the amount of 12b-1 fees that funds can pay. Known variable insurance products that use 12b-1 fee payments typically assess 25 basis points against the value of the policy (i.e., 0.25%, with one basis point being 0.01%) as a servicing cost.

Insurers typically but not always use a distributor to distribute variable insurance products to consumers. The distributor typically has or is affiliated with a direct sales force or with authorized sales agents that actively solicit customers for these programs. The insurer can pay the distributor for the costs of distributing its products, and in turn, the distributor can pay commissions to the sales force on the insurance company's behalf.

The money insurers use to recoup any upfront payment made to the distributor is largely provided by the above described M&E and CDSC fees. However, the insurer has upfront distribution costs but receives M&E fees over time. Further, the insurer will only receive CDSC fees if the policyholder demands payment of the invested funds. Thus, without another source of funds the insurer may not have sufficient cash on hand to pay the full commissions that are owed to the sales agents at the time they sell products. This may seriously limit the insurer's ability to expand or sustain its sales of variable insurance products i.e. to pay its sales force to solicit new policyholders. In short, the insurer/distributor may be obligated to pay today moneys it does not yet have to compensate the sales force. This problem can be exacerbated when policyholders do not withdraw funds early or surrender their policies and when poor market performance decreases the value of the policyholder's policy, thereby reducing M&E fee revenue.

It is currently possible for an insurer to finance the distribution costs via the M&E and CDSC fees that it will collect in the future. However, except on a few rare occasions, currently known methods of financing these fees have not been exploited. One obstacle is that under the structures of current methods even with financing, the accounting treatment for US Generally Accepted Accounting Principles (“GAAP”) stipulates that the insurer must post a Deferred Acquisition Cost (“DAC”) on its balance sheet for its distribution costs. According to US Statutory Code (“STAT”), an accounting liability will be established for the amount of fees financed. Thus, there is no immediate income recognition of the proceeds that are received from the amount that is financed under both GAAP and STAT. This aspect makes the financing of distribution costs via M&E fees less desirable for an insurer.

### SUMMARY OF THE INVENTION

In accordance with embodiments of the invention a sub-account, a segregated portion of an insurer investment account, includes a portfolio of market based investments, funds with at least a portion of one or more premium payments that have invested on behalf of a policyholder, and also includes an asset based sales charge that is collected from the invested policyholder premiums as authorized by the Investment Company Act.

In one embodiment, at least a portion of said asset based sales charge is used to recoup an insurers distribution costs, such as the cost of paying broker commissions, for a product that invests funds in the sub-account. In accordance with some embodiments the Investment Company Act authorized sales charge is a 12b-1 fee, or more particularly, the distribution portion of such a fee. A contingent deferred sales charge may also be deducted as an asset based sales charge in accordance with some embodiments.

In one embodiment, an insurer can increase its cash flow by paying its distribution costs from these asset based fees. In one embodiment, an insurer can increase cash flow by obtaining financing for such fees. In one such financing arrangement, the asset base fees can be forwarded to a financing company in exchange for a lump sum payment of cash.

Other embodiments of the invention and features thereof will become apparent from the following detailed description, considered in conjunction with the accompanying drawing figures.

### BRIEF DESCRIPTION OF THE DRAWINGS

FIG. 1 is a schematic illustrating a prior art method of distributing fees that are collected in conjunction with the servicing of variable life products;

FIG. 2 is a schematic illustrating the relationship between the policyholder, insurer, sub-accounts, distributor, sales force and financing company according to one embodiment of the present invention;

FIG. 3 is a spreadsheet illustrating exemplary scenarios of financing 12b-1 distribution fees and CDSC fees according to an embodiment of the invention; and

FIG. 4 is a spreadsheet illustrating several exemplary scenarios of financing 12b-1 distribution fees and CDSC fees according to another embodiment of the invention.

### DETAILED DESCRIPTION OF PREFERRED EMBODIMENTS

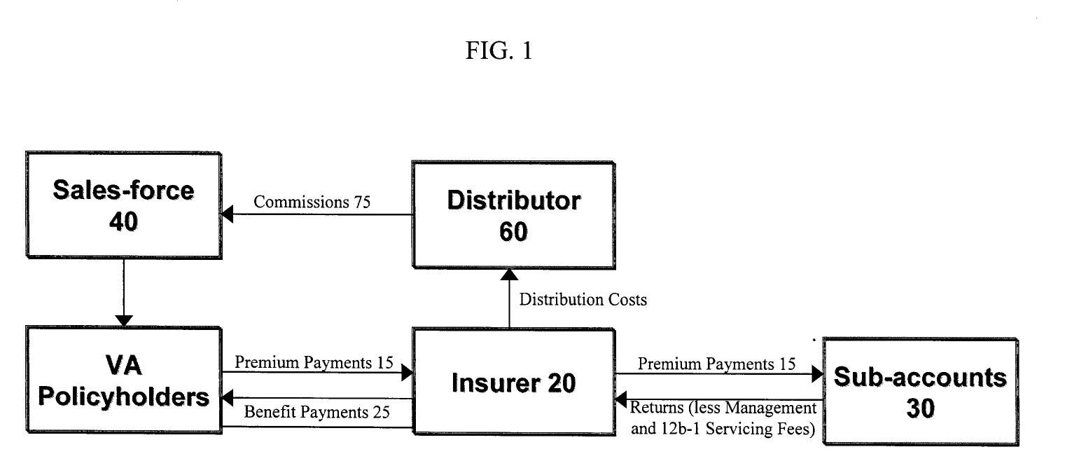

Certain embodiments of the present invention will now be described with reference to the foregoing figures. FIG. 1 illustrates the relationship of the various entities that are involved in the sale and distribution of variable insurance products. As shown, Policyholder 10 enters into a variable insurance product with an Insurer 20, pursuant to which Insurer 20 agrees to make Benefit Payments 25 to either Policyholder 10 or to a Beneficiary 11 at some time in the future in exchange for Premium Payments 15 that are first paid by Policyholder 10. Policyholder 10 may deliver Premium Payments 15 as a lump sum or by making periodic payments over a period of time, in accordance with the terms of the policy.

Pursuant to the policy, Insurer 20 will invest Premium Payments 15 in one or more Sub-accounts 30 that has been selected by Policyholder 10 in accordance with the identified investment objectives. More specifically, Premium Payments 15 will be allocated to the funds in sub-accounts 30, and the funds will be invested in portfolios of securities that are designed and managed by Sub-advisors 70. For each Sub-account 30, the allocated portion of Premium Payment 15 will be converted to a number of units in proportion to the value of the premium relative to that of the Sub-account 30. Policyholder 10 will accumulate additional units with each Premium Payment 15. When Benefit Payments 25 are to be paid, the number of units that have been accumulated by Policyholder 10 will be converted to a dollar benefit, depending upon the then current value of the Sub-accounts 30 in which Policyholder 10 has invested. The value of each variable insurance product will therefore, depend upon the performances of Sub-accounts 30 over the course of the policy.

The value of the policy also depends upon the various fees and charges that have been charged to Policyholder 10. More specifically, two levels of fees will be deducted from value of the policy. Insurer 20 will collect fees at the policy level out of the returns that Policyholder 10 earns from the invested Premium Payments 15. These policy level fees will be in addition to the sub-account level fees that have been paid from Sub-account 30 assets, inclusive of a 12b-1 servicing fees and investment management fees. Both levels of fees will be reflected before any Benefit Payments 25 are paid to Policyholder 10.

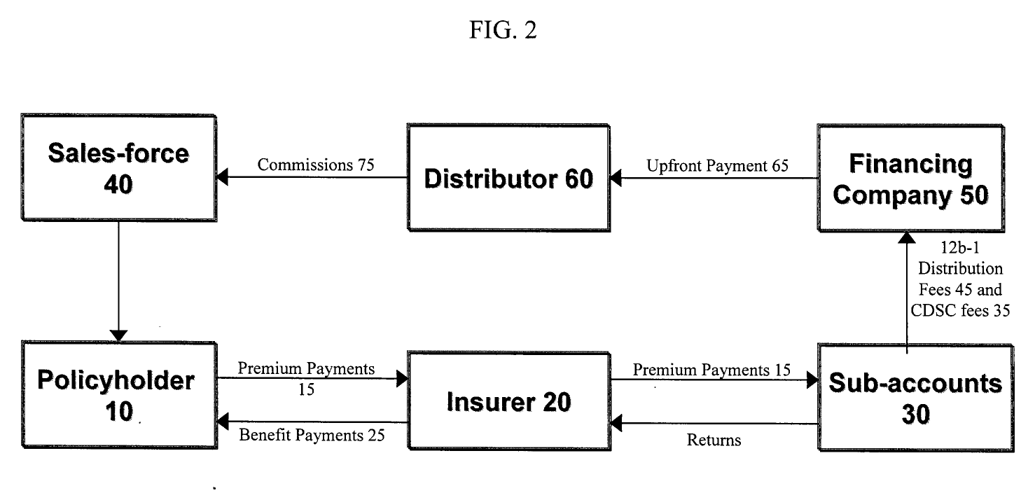

Referring to FIG. 2, having discussed the general relationship among entities involved in a variable insurance product, examples of ways to operate such a program in accordance with embodiments of the present invention will now be described. In one embodiment of the invention, the costs of distributing a variable life product can be paid by the Sub-advisor 70 from the assets of Sub-account 30, which, in the present embodiment, will include CDSC fees, 35 and 12b-1 distribution portion 45 (as well as servicing portion) fees. In one embodiment, Insurer 20 may still be obligated to perform the distribution tasks that it performed using prior art methods, and Sub-account 30 can pay a 12b-1 fee to reimburse Insurer 20 for its costs. In another embodiment, Sub-account 30 may assume the responsibility for all tasks of distributing the variable insurance products and pay a 12b-1 fee to cover its own costs. In yet another embodiment, Sub-account 30 could use a third party to undertake the distribution tasks, and 12b-1 fees could be used to pay the third party.

In any event, in accordance with embodiments of the invention, the component of M&E fee 55 that Insurer 20 currently imposes to cover its costs of distributing variable insurance products can be paid from the funds in sub-accounts 30, rather than from M&E fees that Insurer 20 has not yet received. Since more structuring and financing options are available for use with 12b-1 fees, Insurer 20 will not have to rely as heavily, and perhaps will not have to rely at all, upon M&E fees to recoup its upfront costs.

Additional options are available when Policyholder 10 chooses to surrender the policy. In embodiments of the invention, at least some of CDSC fee 35 will be charged from Sub-account 30, rather than as a policy level charge to Policyholder 10. In such a case, Insurer 20 can reduce the CDSC charged at the policy level

As explained earlier, the current accounting structure requires Insurer 20 to show financed funds as debt/DAC on its balance sheet. However, and Product Distributors 60 do not follow the same accounting standards. Instead, the 12b-1 and CDSC fees charged by Sub-account 30 can be financed, without the undesirable results of being unable to immediately recognize this income, as would be the case were Insurer 20 to finance these M&E and/or CDSC fees at the policy level.

Still referring to FIG. 2, in accordance with an embodiment, financing can be obtained for the distribution portion of the 12b-1 fees and for any CDSC fees paid by Sub-account 30. Financing Company 50 can deliver an Upfront Payment 65 (or some set of installment payments), which can be used to pay Commissions 75 to Sales-force 40. For example, in one embodiment, Financing Company 50 can deliver Upfront Payment 65 directly to Insurer 20. In another embodiment, Insurer 20 can forward at least a portion of Upfront Payment 65 it receives from Financing Company 50 to Distributor 60 as a lump sum. In another embodiment, Insurer 20 can forward Upfront Payment 65 to Distributor in installments.

In another embodiment, Sub-advisor 70 could deliver Upfront Payment to Distributor 60. Either Insurer 20, Distributor 60, an authorized their party or any appropriate combination of entities can pay Commissions 70 to Sales-Force 40.

One or more financing agreements could be entered to finance the stream of payments that will be paid by Sub-account 30. For example, a single financing agreement could be entered with a single Financing Company 50 for each Sub-account 30, a single fee financing agreement could be entered with a single Financing Company 50 for multiple sub-accounts 30, multiple fee financing agreements could be entered with multiple Financing Companies 50 for one or more sub-accounts 30 or any other reasonable fee financing arrangements can be made.

In accordance with embodiments of the invention, Financing Company 50 essentially provides financing for variable insurance products in return for an asset based charge (i.e., fees 12b-1 distribution cost fee) and/or CDSC fees that would otherwise be received by Insurer 20. Financing Company 50 may charge an additional fee for providing this financing, with the amount of such a fee being calculated in any number of ways.

For example, in some embodiments, Financing Company 50 could charge a fee that is be based upon the present value of the payment stream that is expected over the course of the financing arrangement. In other embodiments, the fee may be based upon the value of the sub-accounts 30 whose fees are being financed. In still other embodiment, the fee may be a set dollar amount or it may be set at an amount that depends upon the initial investments of the policyholders who invest in the account (e.g. $100 for each initial investment less than $1000 and $50 for each initial investment greater than or equal to $1000; 4% for each initial investment less than $2500 and 8% for each initial investment greater than or equal to $2500; etc.). Other schemes for calculating a fee that will be acceptable to Financing Company 50 can be ascertained by those having ordinary skill in the art.

Once the financing arrangement has been entered, Financing Company 50 can receive: the 12b-1 distribution fees that would otherwise have been collected by Insurer 20 as a portion of an M&E fee; and the 12b-1 and any CDSC fees that would ordinarily have been assessed at the policy level.

In the present embodiment of the invention, Insurer 20 will continue to deduct an M&E fee from the returns from Sub-account 30 before payment is made to Policyholder 10, in a manner similar to that used by known variable insurance products. However, in accordance with embodiments of the invention, the M&E fee charged by Insurer 20 can be smaller than that which is typically charged to Policyholders 10. Specifically, the M&E fee of the present embodiment can exclude the charge that is regularly included for the distribution costs of Insurer 20.

Fees for the distribution costs of Insurer 20 are instead deducted at the sub-account level along with any CDSCs that are owed. This stream of payments can be financed in exchange for a lump sum payment. Financing Company 50 can deliver the lump sum to Insurer 20, Distributor 60 or directly to Sales-Force 40 in order to pay sales commissions. Thus, the present invention allows Insurer 20 to immediately pay its distribution costs, mainly the commissions that are owed to Sales-Force 40, rather than run the risk of being unable to sustain the program by relying on fees that are received over time.

While the 12b-1 fees that are paid in accordance with embodiments of the invention may be higher than those being paid by competing Sub-accounts 30, the increased 12b-1 fees can be offset by a reduction of the M&E fees that are charged at the policy level. Therefore, the returns that are ultimately received by Policyholders 10 may not be significantly affected. In some embodiments, 12b-1 fees may be 100 basis points (i.e. 1%) of the value of the account. However, it is to be understood that the 12b-1 fees may be any amount authorized by law.

This arrangement thus eliminates the need for Insurer 20 to finance its M&E fees, per se. However, other appropriate arrangements can be made, including payment of the upfront advance to Insurer 20 for distribution to Sales-Force 40, direct distribution of the upfront advance to Sales-Force 40 by Financing Company 50, etc.

Fee Financing Scenarios

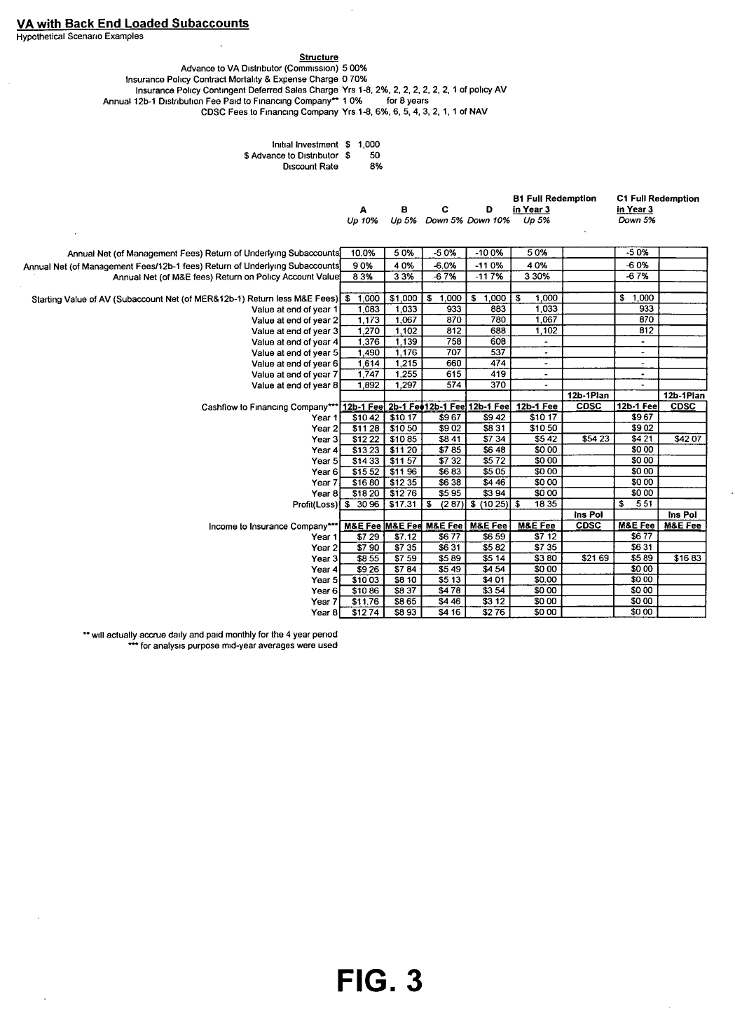

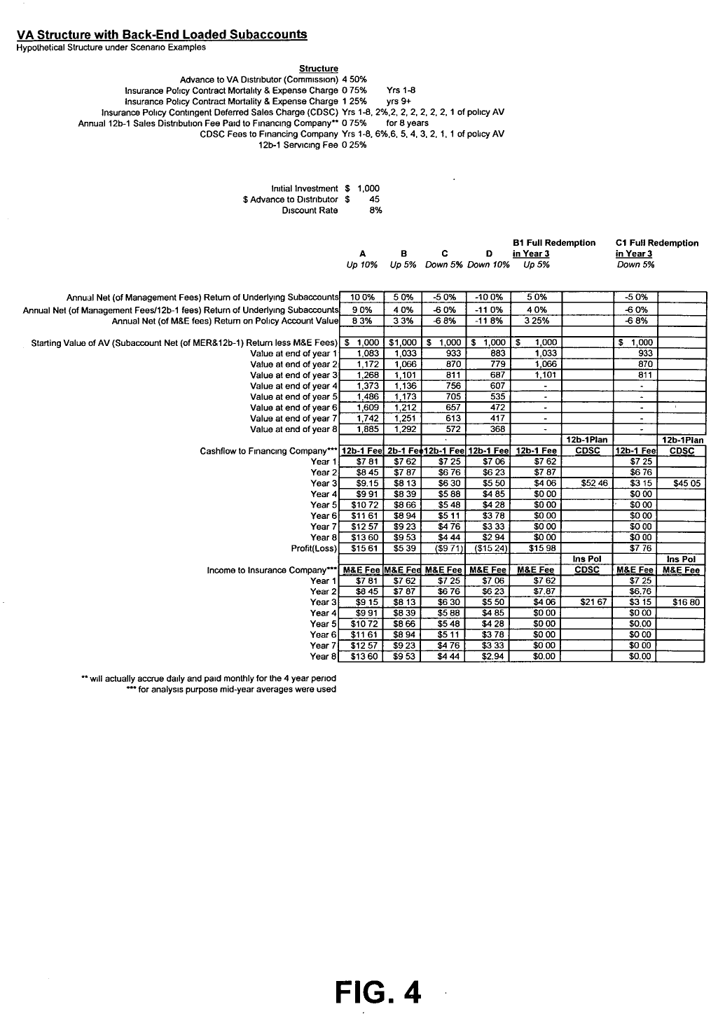

FIGS. 3 and 4 are spreadsheets that illustrate profits and losses that may be realized by Financing Company 50 and the account values on which they are based, when distribution and/or CDSCs are financed in accordance with various embodiments of the invention. The embodiments that are illustrated all operate under a common set of assumptions. Namely: (1) the initial investment in the account is $1000; (2) Financing Company 50 purchases the 12b-1 distribution fees and the CDSC fees from the Sub-accounts 30 for a one time distribution fee equal to 5.0% of the initial investment in FIG. 3 and 4.5% for FIG. 4; (4) Insurer 20 charges an annual M&E fee equal to 0.70% for all years in FIG. 3 and 0.75% for year 1-8 and 1.25% for years 9 and later for FIG. 4; (5) Sub-accounts 30 assess a total annual 12b-1 fee equal to 1% all for distribution costs in FIG. 3 and 1% 12b-1 fee (0.75% for distribution costs and 0.25% for servicing costs) for FIG. 4, which the 0.75% distribution cost portion of the 12b-1 fee is purchased by Financing Company 50; (6) over the course of the accumulation period of eight years, the CDSC fee charged by the Sub-accounts 30 and purchased by Financing Company 50 declines from 6.0% of the account value during the first two years, 5.0% during the third year, and 4.0%, 3.0%, 2.0%, 1.0,1.0% during each successive year, respectively, and is payable only when the account is redeemed prior to the end of the eighth year; and (7) The impact of the free withdrawal provision has not been included in the analysis (profits to Financing Company 50 would be reduced by this provision). It is understood that the fees, percentages and bases for determining the fees that are provided with these examples are merely illustrative, and are provided only to demonstrate embodiments of the invention.

In general, six scenarios (A-D, B1 and C1) in which Financing Company 50 purchases the distribution portion of the 12b-1 fees (and where applicable, CDSC fees 68) are illustrated in each FIG. 3. In two scenarios (A, B), the net account value increases and Financing Company 50 earns a profit by purchasing the future cash flow of the 12b-1 distribution and CDSC fees, in one scenario (C), the net account value decreases and Financing Company 50 does not earn a profit does not earn a profit, in another scenario (D), the net account value decreases and Financing Company 50 also does not earn a profit, and in two more scenarios (B1, C1), Policyholder 10 redeems its investment prior to the end of the eight years, and thus pays the CDSC fees in addition to 12b-1 fees while remained in the policy.

The net policy value, the value of the M&E fee and the 12b-1 and CDSC fees paid to the Finance Company 50 for eight years are provided for each scenario. In the embodiments of FIGS. 3 and 4, values of the account at mid-year were used to determine the amount of the annual fees. However, fees many accrue in many different ways, and the invention are not limited to this embodiment. In another embodiment, fees accrue daily and are paid monthly.

The profit or loss that Financing Company 50 could realize if Policyholder 10 surrenders the policy is also illustrated. Such profit or loss represents the difference between the upfront payment made by Financing Company 50 (5.0% of $1,000 equals $50 for FIG. 3) and the net present value (NPV) at the time the policy is purchased by Policyholder 10, of the total cash flow that is actually received by Financing Company 50 before the policy is surrendered. In calculating the NPV, an exemplary annual NPV rate of 8.0% was used. Accordingly, a comparison of the upfront cash advance made by Financing Company 50 and the NPV of the financed future cash flow shows whether Financing Company 50 would have earned a profit by financing the cash flow that was actually received instead of the cash flow that was expected. If the difference between the upfront cash flow and the NPV is a positive value, Financing Company 50 earned a profit in spite of the policy being surrendered, if the difference is a negative value, the surrender caused Financing Company 50 to not earn a profit.

Turning first to FIG. 3, in scenario A, the value of sub-account 30 (less management fees) increases in value at a rate of 10.0% per year. Payment of the distribution portion of 12b-1 fees (1%) reduces the actual rate of return to the Policyholder for the underlying sub-accounts to 9% and it is further reduced to 8.3% when the M&E fee of 0.70% is charged. While no other fees are assumed in the examples illustrated here, other fees may be included in various embodiments. After the first year, the value of the policy is $1,083.00, and the first year 12b-1 fees are $10.42 (1.0% of $1,041.50, the mid-year average value of the account). No CDSC fees are paid, since Policyholder 10 does not redeem or terminate the account during the eight year accumulation period.

The total NPV of the 12b-1 fees is approximately equal to the sum of the mid-year value of the account for each year discounted at 8% (i.e., the value of the account at the middle of year 1 discounted with ½ year of interest at 8% per year, plus the value of the account at the middle of year 2 discounted for 1 and ½ years at 8% per year, plus the value of the account at the middle of year 3 discounted for 2 and ½ years at 8% per year, etc.). At the end of eight years, the profit to Financing Company 50 would be $30.96.

In scenario B, the value of sub-account 30 net of management fees increases by value 5.0% per year, also generating a profit for Financing Company 50. As shown in the second column of FIG. 3, scenario B results in a profit of $17.31.

In scenarios C and D, Financing Company 50 does not earn a profit by purchasing these cash flows. In scenario C, sub-account 30 declines at a rate of 5.0% per year after investment management fees, resulting in a net loss to Financing Company 50 of $2.87. In scenario D, sub-account 30 declines 10.0% per year after investment management fees only, resulting in a loss of $10.25 to Financing Company 50.

In the last two scenarios B1 and C1 illustrated in FIG. 3, Policyholder 10 fully redeems the policy, in these examples, after two and one half years. In scenario B1 sub-account has produced an annual return of 5.0%, therefore, the annual fees for the first two years are the same as that illustrated in scenario B. The fee charged in scenario B1 for the third year is approximately one-half of that of scenario B, since the policy is surrendered after only half of the year. Because Policyholder 10 redeems the account, a CDSC of $54.23 (5.0%, the percentage for redemption during the third year of the account, of $1085, the value of the account after two and one half years). The NPV of both the 12b-1 distribution portion and CDSC is $68.35, resulting in a profit of $18.35 for Financing Company 50.

In scenario C1 sub-account 30 loses 5.0% per year. The annual fees equal those of scenario C until policyholder 10 redeems the account. However, Financing Company only receives a CDSC (which is asset based) of only $42.07 (5.0% of $841, the account value after two and one-half years), generating a profit of $5.51 to Financing Company 50.

In the scenarios illustrated in FIG. 4, returns generated by sub-account 30 are the same as those provided in FIG. 3. That is, in scenario A, sub-account 30 earns 10%, in scenario B, sub-account 30 earns 5%, in scenario C, sub-account 30 loses 5% and in scenario D, sub-account 30 loses 10%. In scenarios B1 and C1, the earnings of sub-account 30 are the same as in scenarios B and C respectively and Policyholder 10 again redeems the policy in the third year. The M&E charges that are deducted at the policy level are 0.75% of the value of the account for the first 8 years. But for the examples shown in FIG. 4, the 12b-1 fees paid from sub-account 30 to the Finance Company 50 have been reduced from 1.0% to 0.75%.

In scenario A, payment of the total 1.0% 12b-1 fees reduces the rate of return to Policyholder 10 from sub-account 30 to 9.0% and it is further reduced to 8.25% when the 0.75% M&E fee is charged. At the end of year 1, the value of the policy is $1,083.00, and the first year 12b-1 fees are $7.81 (0.75% of $1,041, the mid-year average value of the account) and no CDSCs are paid. At the end of eight years, the profit to Financing Company 50 is $15.61. In scenario B, the rate of return to Policyholder 10 is 3.25% and the profit to Financing Company 50 is $5.39.

In scenarios C and D, Policyholder's 10 sub-accounts decline in value. In scenario C sub-account 30 declines−5.0% in value and in scenario D it declines−10.0%. Again, no CDSCs are paid. Financing Company 50 loses $9.71 and $15.24, respectively.

In scenarios B1 and C1, Policyholder 10 again fully redeems the policy halfway through the third year. In scenario B1, Policyholder 10 earns 3.25% from the policy after all charges are assessed. Financing Company 50 receives a CDSC of $52.46 and profits $15.98. In scenario C1, Policyholder 10 loses 6.75% per year after all fees are assessed on the policy and pays a CDSC of $45.05. In contrast, Financing Company 50 profits $7.76. Thus, as FIGS. 3 and 4 illustrate, the profits that are realized by Financing Company 50 can vary significantly as the future fees are variable or unknown in nature.

It is to be understood that the foregoing embodiments may be implemented in any number of manners, including automated and semi-automated processes utilizing computer hardware and software. Portions of the foregoing processes may be implemented in software, including, for example, determination of when any of the foregoing fees are due, effectuating the investment in the sub-accounts or other assets, calculation of any of the foregoing fees, calculation of account values, determination of appropriate hedging strategies/transactions entered into by Financing Company to mitigate risk associated with entering into the financing arrangement and the like.

Those skilled in the art will recognize that the method and system of the present invention has many applications, may be implemented in many manners and, as such, is not limited to the foregoing exemplary embodiments and examples. Moreover, the scope of the present invention covers conventionally known and future develop the variations and modifications to the system components and processes described herein as would be understood by those skilled in the art.

Those skilled in the art will recognize that the method and system of the present invention has many applications, may be implemented in many manners and, as such, is not limited to the foregoing exemplary embodiments and examples. Moreover, the scope of the present invention covers conventionally known and future develop the variations and modifications to the system components and processes described herein as would be understood by those skilled in the art.

1. A sub-account of an insurer investment account, comprising:
a portfolio of market based investments;
funds that include at least a portion of one or more premium payments provided by a policyholder; and
an asset based sales charge collected from said funds in accordance with the Investment Company Act.

2. A sub-account as claimed in claim 1, wherein at least a portion of said asset based sales charge recoups a distribution cost of a product that uses the sub-account.

3. A sub-account as claimed in claim 1 further comprising deducting a contingent deferred sales charge as at least a portion of said asset based sales charge.

4. A method of increasing cash flow to a variable insurance product provider, comprising using at least a portion of an Investment Company Act authorized fee to pay a distribution cost for a variable insurance product.

5. A method of increasing cash flow to a variable insurance product provider wherein said Investment Act authorized fee is a 12b-1 fee.

6. A method of increasing cash flow to a variable insurance product provider as claimed in claim 5 further comprising forwarding said asset based sales charge to a financing company in exchange for a lump sum payment of funds.

7. A method of increasing cash flow to a variable insurance product provider as claimed in claim 6 further comprising delivering at least a portion of said lump sum payment as a source of funds for a sales force commission.

8. A method of providing financing for a variable insurance product fee payment stream, comprising:
providing upfront payment of a variable insurance product distribution cost; and
in exchange for said upfront payment, accepting a periodically assessed Investment Company Act authorized asset based sales charge.

9. A method of providing financing as claimed in claim 8 wherein the insurance product fee payment stream includes a 12b-1 fee for an insurer distribution cost.

10. A method of providing financing as claimed in claim 9 wherein said asset based sales charge includes a distribution portion of a 12b-1 fee.

11. A method of providing financing as claimed in claim 8 further comprising deducting a contingent deferred sales charge as at least a portion of said asset based sales charge.

12. A method of delivering a variable insurance product benefit, comprising:
deducting an Investment Company Act authorized asset based charge from an investment fund in which a policyholder premium is invested, thereby creating a sub-account policyholder return; and
forwarding an allocated portion of the sub-account policyholder return to said policyholder as a benefit, wherein said allocated sub-account portion is a proportionate share of said sub-account based dependent upon said policyholder premium.

13. A method of delivering a variable insurance product benefit as claimed in claim 12, further comprising:
accepting a premium deposit from a policyholder; and
investing said policyholder premium in said investment fund.

14. A method of delivering a variable insurance product benefit as claimed in claim 13, further comprising:
accepting a lump sum payment in an amount estimated as a total distribution fee to be received from a plurality of said policyholders having premiums in said investment fund; and
in exchange for said lump sum payment, periodically delivering deducted asset based charges relating to said plurality of said policyholders to a financing company.
